(19) United States
(12) Patent Application Publication
(10) Pub. No.: US 2025/0220491 A1
(43) Pub. Date: Jul. 3, 2025

(54) DATA TRAFFIC ROUTING FOR INTERNET SERVICE CONNECTIVITY DISRUPTIONS IN A 5G COMMUNICATION NETWORK

(71) Applicant: DISH Wireless L.L.C., Englewood, CO (US)

(72) Inventors: Arjun Sarath, Highlands Ranch, CO (US); Manvendra Pratap Singh, Highlands Ranch, CO (US); Afif ur Rahman, Ontario (CA); Ravi Madhavan, Naperville, IL (US); Mohammad Dawood Shahdad, Aurora, CO (US)

(21) Appl. No.: 18/397,988

(22) Filed: Dec. 27, 2023

(51) Int. Cl. H04W 28/02; H04L 45/28

(52) U.S. Cl. CPC H04W 28/0231; H04L 45/28

(57) ABSTRACT

A method for routing data traffic for an Internet service in a communication network includes detecting, using an Internet service disruption routing module, a failure of a component in a first Internet service chain in the communication network. The first Internet service chain includes a first user plane function (UPF) and a first Internet interface, and has at least one assigned session. The method further includes selecting, using the Internet service disruption routing module, at least one component of a second Internet service chain, transmitting, using the Internet service disruption routing module, a signal to a RAN in the communication network indicating the selected at least one component of the second Internet service chain, and redirecting, using the RAN, data traffic for the at least one assigned session of the first Internet service chain to the at least one component of the second Internet service chain.

### FIELD

The present disclosure relates generally to wireless communication networks and, more particularly, to systems and methods for routing data traffic for an Internet service in a communication network based on a loss of Internet service connectivity.

### BACKGROUND

Wireless communication networks, such as fifth generation (5G) communication networks, are being deployed around the world. These 5G networks use emerging technologies to support data and voice communications with millions, if not billions, of mobile phones, computers, and other devices. 5G technologies are capable of supplying much greater bandwidths than was previously available. One common function of wireless communication networks is providing a user equipment (UE) device with access to external data networks (DNs) such as the Internet. Typically, if there is a failure of a component in the communication network related to providing access to a DN such as the Internet, the UE will experience a disruption or loss of Internet service connectivity. An operator of the UE may be required to establish a new session to access the Internet service, for example, restart an application (e.g., a Web browser) on the UE.

### SUMMARY

In accordance with an embodiment, a method for routing data traffic for an Internet service in a communication network includes detecting, using an Internet service disruption routing module, a failure of a component in a first Internet service chain in the communication network. The first Internet service chain includes a first user plane function (UPF) and a first Internet interface and the first Internet service chain has at least one assigned session. The method further includes selecting, using the Internet service disruption routing module, at least one component of a second Internet service chain, transmitting, using the Internet service disruption routing module, a signal to a radio access network (RAN) in the communication network indicating the selected at least one component of the second Internet service chain, and redirecting, using the RAN, data traffic for the at least one assigned session of the first Internet service chain to the at least one component of the second Internet service chain.

In accordance wither another embodiment, a system for routing data traffic for an Internet service in a communication network, the system includes a memory that stores one or more computer readable media that include instructions, and one or more processor devices. The one or more processor devices execute the instructions of the computer readable media to perform a process including detecting a failure of a component in a first Internet service chain in the communication network. The first Internet service chain includes a first user plane function (UPF) and a first Internet interface and the first Internet service chain has at least one assigned session. The process further includes selecting at least one component of a second Internet service chain, transmitting a signal to a radio access network (RAN) in the communication network indicating the selected at least one component of the second Internet service chain, and redirecting data traffic for the at least one assigned session of the first Internet service chain to the at least one component of the second Internet service chain.

In accordance with another embodiment, a non-transitory, computer-readable medium storing instructions that, when executed by an electronic processor, perform a set of functions including detecting, using an Internet service disruption routing module, a failure of a component in a first Internet service chain in the communication network. The first Internet service chain includes a first user plane function (UPF) and a first Internet interface and the first Internet service chain has at least one assigned session. The functions further include selecting, using the Internet service disruption routing module, at least one component of a second Internet service chain, transmitting, using the Internet service disruption routing module, a signal to a radio access network (RAN) in the communication network indicating the selected at least one component of the second Internet service chain, and redirecting, using the RAN, data traffic for the at least one assigned session of the first Internet service chain to the at least one component of the second Internet service chain.

### BRIEF DESCRIPTION OF THE DRAWINGS

The present disclosure will hereafter be described with reference to the accompanying drawings, wherein like reference numerals denote like elements.

FIG. 1 is a schematic block diagram of an example wireless communication network in accordance with an embodiment;

FIG. 2 is a schematic block diagram of an example architecture of a core of a wireless communication network in accordance with an embodiment;

FIG. 3 is a schematic block diagram of a system for routing data traffic for an Internet service in a communication network in accordance with an embodiment;

FIG. 4 is a schematic block diagram of a system for routing data traffic for an Internet service in a communication network in accordance with an embodiment;

FIG. 5 illustrates a method for routing data traffic for an Internet service in a communication network in accordance with an embodiment; and

FIG. 6 is a block diagram of an example computer system in accordance with an embodiment.

### DETAILED DESCRIPTION

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology can be implemented in software (for example, stored on non-transitory computer-readable medium) executable by one or more electronic processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computer device or can be distributed among different computing devices connected by one or more networks or other suitable communication links.

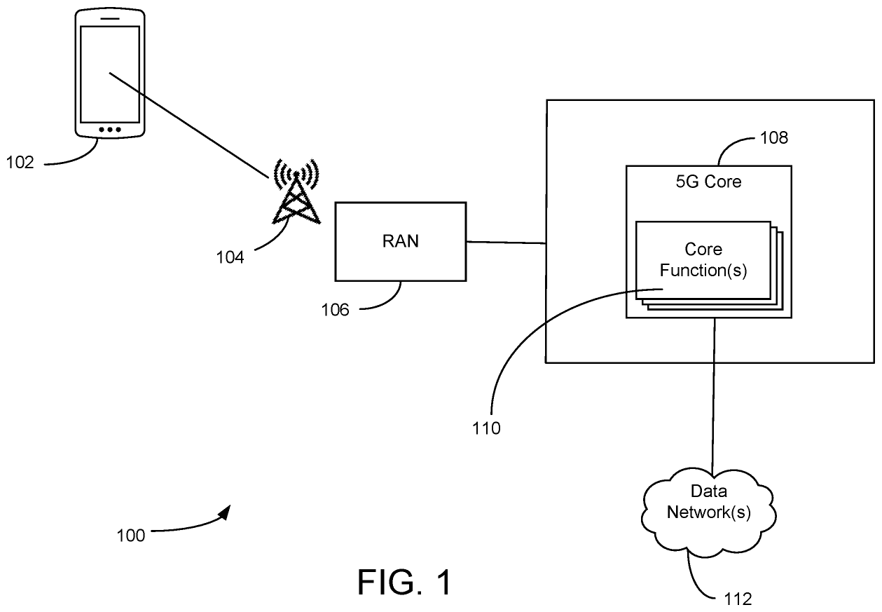

FIG. 1 is a schematic block diagram of an example wireless communication network in accordance with an embodiment. The wireless communication network 100 can include a user equipment (UE) device 102, a radio access network (RAN) 106, and a 5G core 108. The RAN 106 and 5G core 108 can enable the UE device 102 to, for example, communicate with other UE devices and to communicate with one or more external data networks (DNS) 112 (e.g., the Internet or a private corporate network) using the RAN 106 and 5G core 108. For example, if the external data network 112 is the Internet, the RAN 106 and 5G core 108 can allow the UE device 102 to send and receive data via the Internet. While FIG. 1 illustrates various components of communication network 100, other embodiments of communication network 100 can vary the arrangement, communication paths, and specific components of communication network 100. In some embodiments, the wireless communication network 100 can include fewer, additional, or different components in different configurations than illustrated in FIG. 1. For example, in some embodiments, the wireless communication network 100 may include additional or different UE devices 102.

The wireless communication network 100 may be used to facilitate multiple types of communication sessions, such as, for example, voice calls, video calls, messaging, data transmission, and/or other types of communications. The wireless communication network 100 may represent a portion of a wireless network built around 5G (fifth generation) standards promulgated by standards setting organizations under the umbrella of the Third Generation Partnership Project (3GPP). Accordingly, in some configurations, the wireless communication network 100 may be a 5G network, such as, for example, a 5G cellular network. Such 5G networks, including the wireless communication network 100, may comply with industry standards, such as, for example, the Open Radio Access Network (Open RAN or O-RAN) standard that describes interactions between the network and user equipment (e.g., mobile phones and the like). The O-RAN model follows a virtualized model for a 5G wireless architecture in which 5G base stations (gNBs) are implemented using separate centralized units (CUs), distributed units (DUs), and radio units (RUs). In some configurations, O-Ran CUs and DUs may be implemented using software modules executed by distributed (e.g., cloud) computing hardware.

In some configurations, the wireless communication network 100 may be a standalone (SA) network (e.g., a 5G SA network) that utilizes 5G cells for both signaling and information transfer via a 5G packet core architecture. In other configurations, the wireless communication network 100 may be a non-standalone (NSA) network that depends on another network, such as, for example, a control plane of a fourth generation (4G) long-term evolution (LTE) network.

As mentioned, in some embodiments, the UE device 102 can transmit data from one or more applications on the UE device 102 to an external data network (DN) 112, for example, the Internet, via the communication network 100. While FIG. 1 illustrates one UE device 102, in some embodiments, it should be understood that the communication network 100 can support a plurality of UE devices 102. UE device 102 can be various forms of wireless devices that are capable of communication according to the radio access technology (RAT) of the wireless communication network 100 (e.g., a 5G new radio (NR) network). For example, in some embodiments, the UE device 102 can be a smartphone, a wireless modem, a cellular phone, a laptop computer, a wireless access point (AP), etc.

After the UE device 102 has established a connection or session with the RAN 106, the communication network 100 can provide data (e.g., data packets) to the UE device 102 and can receive data from the UE device 102. In some embodiments, the data can include, for example, voice data for a phone call, data provided by a web server to the UE device 102, data provided by the UE device 102 to a Web server, or other types of data commonly exchanged on wireless communication networks. For example, after the UE device 102 has established a connection or session with the RAN 106, a user of the UE device 102 may select to stream a video on an application of the UE device 102 via the Internet (e.g. data network 112). The video stream can be provided to the UE device 102 on data packets.

The UE device 102 can communicate with the RAN 106 in various ways, such as, for example, via a radio transceiver 104, which may also be referred to as a radio unit (RU) in the O-RAN architecture. The RAN 106 may be or include a disaggregated RAN (referred to as an Open RAN or O-RAN) which can include hierarchy (e.g., tree structure) of RAN functions. In such examples, the RAN 106 may include on or more CUs and one or more DUs. For example, each of multiple CUs may be coupled with multiple DU, and each DU may be coupled with multiple RUs (e.g., the radio transceiver 104). As such, each UE device 102 can communicate with backhaul network infrastructure (e.g., a 5G Core 108) according to an assigned communication path through a particular RU, DU, and CU. An RU (e.g., the radio transceiver 104) in combination with a DU and CU may be referred to as a gNodeB (gNB) in the O-RAN architecture. Such as gNB may be a 3GPP 5G next generation base station that supports communications with the with the UE device 102.

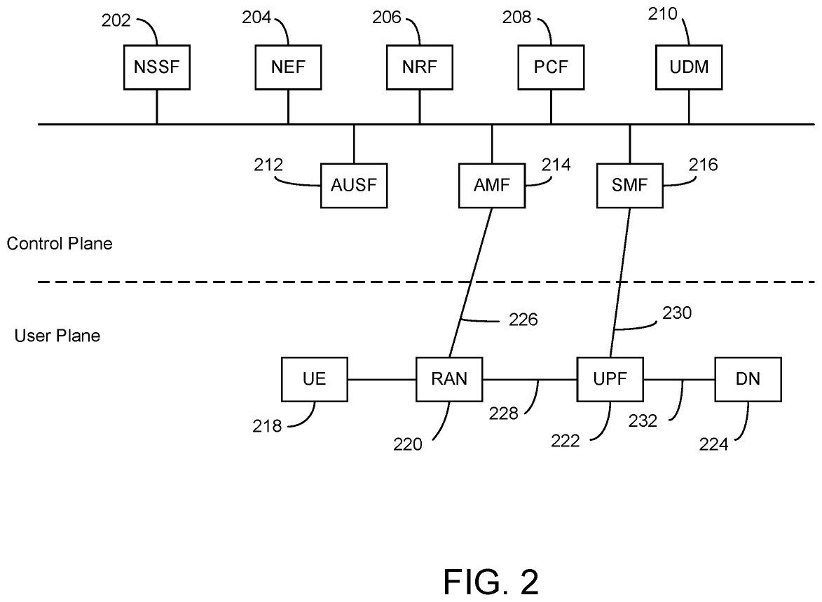

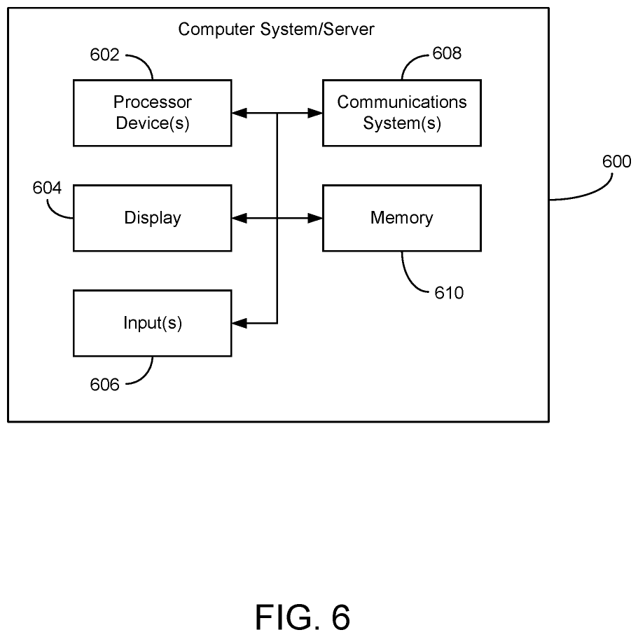

The 5G Core 108 may include one or more core functions 110. Each core function 110 can be a network function (NF) that provides a utility or service specific to the 5G core 108, for example, core functions of the communication network 100. In some embodiments, for example, different NFs may provide different utility to the communication network 100. In some embodiments, the 5G core 108 including the core functions 110 can reside on a cloud computing platform. Examples of various core functions 110 are discussed further below with respect to FIG. 2. In some embodiments, the RAN 106 and the 5G core 108 (including core functions 110) may be implemented on a computer system (e.g., computer system 600 discussed below with respect to FIG. 6) such as a server or the functionality of the RAN 106, the 5G core 108 and core functions 110 may be distributed among multiple servers or devices (e.g., as part of a cloud service or cloud-computing environment).

FIG. 2 is a schematic block diagram of an example architecture of a core of a wireless communication network in accordance with an embodiment. In FIG. 2, the core (e.g., 5G core 108 shown in FIG. 1) architecture including a plurality of network functions (NFs) 202-216 and 222 is illustrated for providing communication between a UE device 218 and a data network 224 (e.g., the Internet). In FIG. 2, the example 5G core is simplified to show some key components, however, implementations can involve additional components. In some embodiments, the communication network (e.g., communication network 100 shown in FIG. 1), or portion thereof, in which the 5G core is implemented may be disaggregated, such that, for example, NFs may be developed or operated by multiple vendors or operators. In some embodiments, an NF may be virtualized. An NF may be virtualized by implementing the NF in a cloud-native architecture. Accordingly, in some embodiments, an NF may be a cloud-native NF (CNF). A CNF may refer to a service (or utility) that performs network duties in software (e.g., as opposed to purpose-built hardware).

In the example architecture illustrated in FIG. 2, the 5G core can include a Network Slice Selection Function (NSSF) 202, a Network Exposure Function (NEF) 204, a Network Repository Function (NRF) 206, a policy control function (PCF) 208, a Unified Data Management (UDM) function 210, an Authentication Server Function (AUSF) 212, an Access and Mobility Management Function (AMF) 214, a Session Management Function (SMF) 216, and a User Plane Function (UPF) 222. The NSSF 202 can provide tailor made logical networks on the physical network, for example, the NSSF can be used by the AMF 214 to assist with the selection of a network slice that will serve a particular UR device. The NEF 204 can expose services and resources over application programming interfaces (APIs) within and outside the 5G core. The NRF 206 can enable 5G network functions (NFs) to register and discover each other via a standards-based application programming interface (API). The PCF 208 can apply session policies for the UE device 218, or other devices, when connecting over, for example, 5G. The UDM 210 can manage network user data in a single, centralized element and can allow for generation of authentication vectors, user identification handling, NF registration management, and retrieval of UE device individual subscription data for slice selection. The AUSF 212 can allow the AMF 214 to authenticate the UE and access services of the 5G core. The AMF 214 can perform operations like mobility management, registration management, connection management, UE-based authentication, etc. The SMF 216 can interact with the decoupled data plane, can perform internet protocol (IP) address allocation and management for UE devices (e.g., UE device 218), user plane selection, and packet routing in conjunction with the UPF 222, etc. The UPF 222 can perform user plane operations, such as maintaining protocol data unit (PDU) sessions, packet routing and forwarding, inspection policy enforcement for the user plane, Quality of Service (QOS) handling, providing data access to the UE 218, etc. A PDU session can provide connectivity between applications on the UE device 218 and the DN 224 (e.g., the Internet). The SMF 216 can also be responsible for creating, updating, and removing PDU sessions, selecting particular UPFs 222 on which to anchor PDU sessions when new UE devices 218 appear on the communication network, and managing session context with the UPF 222. Together with the UPF 222, the SMF 216 can maintain a record of PDU session state by means of a PDU Session ID.

In some embodiments, the UE 218 can communicate with the RAN 220 wirelessly, for example, via a radio transceiver 104 (shown in FIG. 1). The AMF 214 and the RAN 220 can communicate signals or messages with one another over an interface 226, for example, an N2 interface. The RAN 220 and the UPF 222 can communicate signals and data with one another over an interface 228, for example, an N3 interface. The SMF 216 and the UPF 222 can communicate signals or messages with one another over an interface 230, for example, an N4 interface. The UPF 222 can send and receive signals and data with the Internet 224 over an Internet interface 232, for example, an N6 interface. The AMF 214 and the SMF 216 can communicate signals and messages with one another over an interface, for example, an N11 interface.

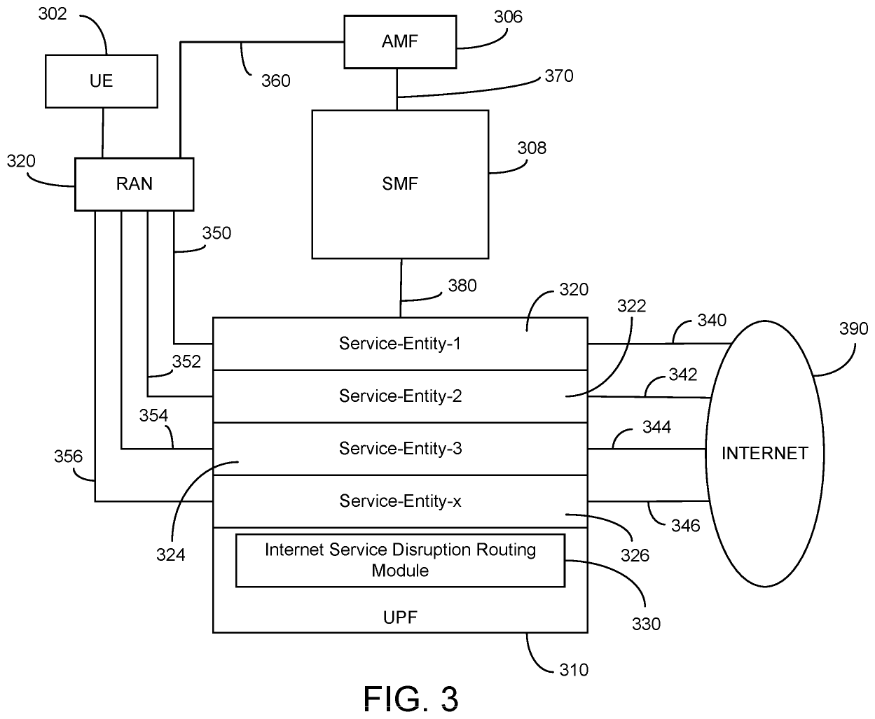

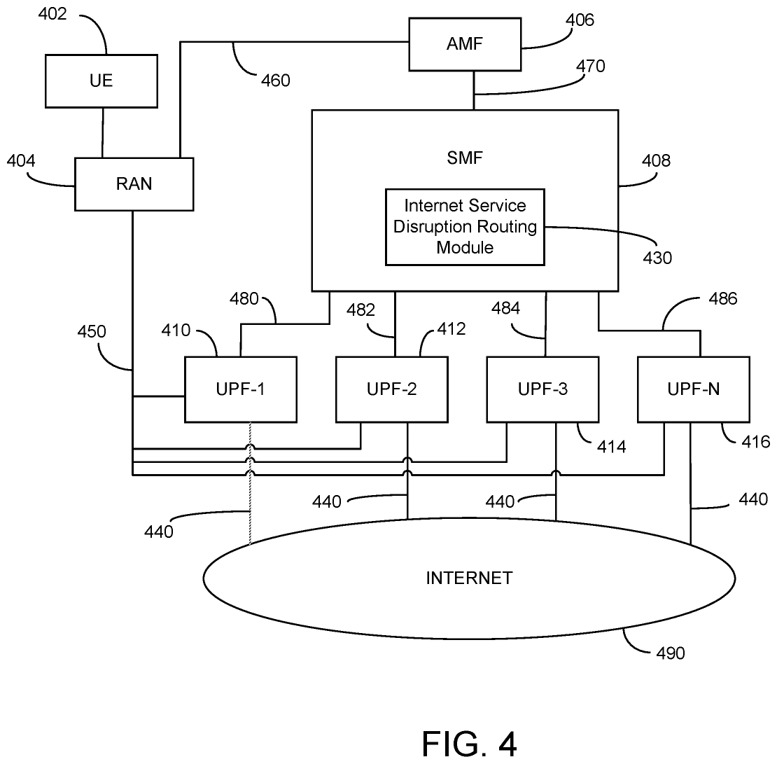

While one UPF 222 is shown in the embodiment illustrated in FIG. 2, it should be understood that, in some embodiments, the SMF 216 may be configured to connect to other numbers, N, of UPFs 222 as described further below with respect to FIG. 4. When the UE 218 establishes a connection or session with the RAN 220, the SMF 216 can be used to assign a UPF 222 to the session to provide connectivity to the Internet 224. In some embodiments, the UPF 222 may be selected based on, for example, geographic location and load (e.g., the number of sessions being handled by the UPF). For example, the SMF 216 may select an available UPF 222 that is closest geographically to the UE device 218 and that also has capacity to handle additional sessions thereon and the associated data traffic. The SMF 216 can then provide relevant information regarding the selected UPF 222 to the RAN 220 (e.g., via the AMF 214). The RAN 220 can then, for example, communicate directly with the selected UPF 222 via the interface 228 to send and receive data between the UE 218 and the UPF 222. The UPF 222 can send and receive data with the Internet via the Internet interface 232. While one Internet interface 232 is shown in FIG. 2, the UPF 222 can include a plurality of service entities which each has an associated Internet interface 232 and an interface 228 with the RAN 220 as discussed further below with respect to FIG. 3. Each service entity and Internet interface 232 can be configured to handle one or more of the sessions assigned to the UPF 222.

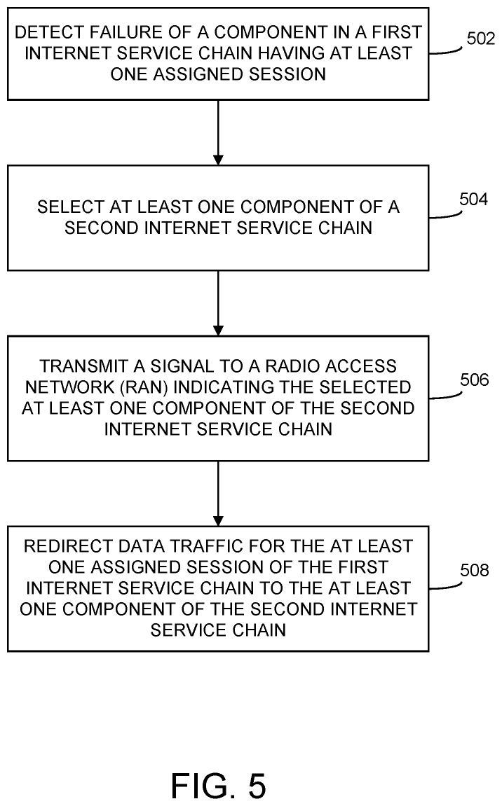

During a session of a UE device 218, a failure of a component of the communication network, in particular components related to providing Internet service (e.g., an Internet service chain) to the UE over the communication network, can cause a disruption or loss of Internet connectivity and a current session for a UE may be timed out. The present disclosure describes systems and methods for routing data traffic for an Internet service in a communication network that allows the UE 218 to continue to access the Internet services when there is a failure of a component in the Internet service chain, i.e., the communication network is able to continue providing service to the UE 218 through other components and Internet service chains. In particular, an internet service disruption routing module (or functionality) may be provided on the SMF 216 and/or the UPF 222 to automatically redirect (or reroute) the data traffic of the UE device 218 session to a different component and Internet service chain. Advantageously, this can allow the session to seamlessly continue and the user and UE device 218 do not see any disruption of service. In some embodiments, the component failure may be failure of a component on the Internet interface 232 as described further below with respect to FIGS. 3 and 5. In such embodiments, when the failure of the component of the Internet interface 232 is detected by the UPF 222, the internet service disruption routing module can be configured to select and assign a different Internet interface (and corresponding service entity) of the UPF for the session and to provide information regarding the selected Internet interface to the RAN 220 so the RAN 220 can redirect (or reroute) the data traffic for the UE device 218 session to the selected Internet interface (and corresponding service entity) of the UPF 222. In some embodiments, the component failure may be the failure of the entire UPF 222 as described further below with respect to FIGS. 4 and 5. In such embodiments, when the failure of the UPF 222 (e.g., a loss of an N4 interface) is detected by the SMF 216, the internet service disruption routing module can be configured to select and assign a different UPF in the communication network and to provide information regarding the selected UPF to the RAN 220 so the RAN 220 can redirect (or reroute) the data traffic for the UE device 218 session to the selected UPF. Advantageously, the disclosed systems and methods provide a mechanism for auto-detection and auto-redirection of data traffic for the UE device 218 session based on a failure of a component of an Internet service chain.

As mentioned, in some embodiments, the component failure may be a failure of a component on the Internet interface between a UPF and the Internet. FIG. 3 is a schematic block diagram of a system for routing data traffic for an Internet service in a communication network in accordance with an embodiment. In FIG. 3, a UE device 302 can establish a connection or session with a RAN 304 to communicate with a data network, for example, the Internet 390. RAN 304 is in communication with an AMF 306 over interface 360 (e.g., an N2 interface). The AMF 306 is also in communication with an SMF 308 over an interface 370 (e.g., an N11 interface). The SMF 308 is also in communication with a UPF 310 over an interface 380 (e.g., an N4 interface). The UPF 310 can include a plurality of service entities. In particular, in FIG. 3, UPF 310 is illustrated with X service entities, a first service entity 320 (Service-Entity-1), a second service entity 322 (Service-Entity-2), a third service entity 324 (Service-Entity-3), and an Xth service entity 326 (Service-Entity-X). Each service entity 320, 322, 324, 326 has a corresponding interface (e.g., an N3 interface) 350,352, 354, 356, respectfully, over which it communicates with the RAN 304. Each service entity 320, 322, 324, 326 also has a corresponding Internet interface (e.g., an N6 interface) 340, 342, 344, 346, respectfully, over which it communicates with the Internet 390. In some embodiments, there may be one or more components on each Internet interface 340, 342, 344, 346. For example, the components along an Internet interface 340, 342, 344, 346 can include firewalls, DDOS (Distributed Denial of Service) gear, routers, etc.

In some embodiments, the UPF 310 can handle a plurality of sessions (e.g., a PDU session) for a plurality of UE devices and each service entity 320, 322, 324, 326 (and corresponding Internet interface 340, 342, 344, 346) of the UPF 310 can handle one or more of the sessions assigned to the UPF 310. Accordingly, the UPF 310 can be configured to assign each session to a service entity 320, 322, 324, 326 and corresponding Internet interface 340, 342, 344, 346, respectfully, and can distribute the total number of sessions assigned to the UPF 310 over the plurality of services entities 320, 322, 324, 326 and corresponding Internet interface 340, 342, 344, 346, respectfully. The interfaces (e.g., an N3 interface) 350,352, 354, 356 corresponding to each service entity 320, 322, 324, 326, respectfully, of the UPF 310 can be used to communicate with the RAN 304.

In some embodiments, an Internet service chain can include UPF 310 and an Internet interface 340, 342, 344, 346 corresponding to a service entity (e.g., one of service entities 320, 322, 324, 326. For example, a first Internet service chain can include UPF 310 and the first Internet interface 340 corresponding to the first service entity 320. A second, different Internet service chain can include UPF 310 and the second Internet interface 342 corresponding to the second service entity 322. A third different Internet service chain can include UPF 310 and the third Internet interface 344 corresponding to the third service entity 344. Each Internet service chain can carry Internet traffic on its Internet interface provided there is an existing Internet session.

The UPF 310 can also include an internet service disruption routing module 330 which can be configured to redirect data traffic for each session handled by an Internet service chain if there is a failure of one or more components of the Internet service chain. For example, in some embodiments, if UPF 310 detects a failure of a component of a first Internet service chain (e.g., including UPF 310 and the Internet interface 340 corresponding to the first service entity 320), the internet service disruption routing module 330 can select the second Internet interface 342 corresponding to the second service entity 342 (i.e., a second Internet service chain) and assign it to one or more of the sessions being handled by the first Internet service chain. In some embodiments, the internet service disruption routing module 330 can redirect all sessions handled by the first Internet service chain to the same alternate Internet interface and corresponding service entity, for example, the second Internet service chain (Internet interface 342 corresponding to service entity 322). In some embodiments, the internet service disruption routing module 330 can distribute the sessions handled by the first Internet service chain over several or all of the other Internet interfaces and corresponding service entities of the UPF 310. For example, the sessions handled by the failed Internet interface (and corresponding service entity) can be distributed based on the load of the other available Internet interfaces (and corresponding service entities). Information regarding the Internet interface and corresponding service entity selected by the internet service disruption routing module 330 may be communicated to the SMF 308, the AMF, 306 and the RAN 304. The RAN 304 may then redirect data traffic over the interface 350, 352, 354, 356 corresponding to the selected Internet interface and corresponding service entity.

As mentioned above, in some embodiments, the component failure may be the failure of the entire UPF and the interface between the SMF and the UPF. FIG. 4 is a schematic block diagram of a system for routing data traffic for an Internet service in a communication network in accordance with an embodiment. In FIG. 4, a UE device 402 can establish a connection or session with a RAN 404 to communicate with a data network, for example, the Internet 490. RAN 404 is in communication with an AMF 406 over interface 460 (e.g., an N2 interface). The AMF 406 is also in communication with an SMF 408 over an interface 470 (e.g., an N11 interface). In the embodiment illustrated in FIG. 4, the SMF 408 is in communication with a plurality of UPFs 410, 412, 414, 416 over an interface (e.g., an N4 interface) 480, 482, 484, 486, respectively. In particular, FIG. 4 illustrates N UPFs, a first UPF 410 (UPF-1), a second UPF 412 (UPF-2), a third UPF 414 (UPF-3), and an Nth UPF 416 (UPF-N). Each UPF 410, 412, 414, 416 has a corresponding Internet interface 440 over which it communicates with the Internet 490.

In some embodiments, each UPF 410, 412, 414, 416 can handle a plurality of sessions (e.g., a PDU session) for a plurality of UE devices. As discussed above with respect to FIG. 3, each UPF 410, 412, 414, 416 may include a plurality of service entities (not shown). Each UPF 410, 412, 414, 416 can also have a corresponding interface (e.g., an N3 interface) 450 over which it communicates with the RAN 404. The SMF 408 may be configured to assign a new session for a UE device 402 to one of the UPFs 410, 412, 414, 416. In some embodiments, the UPF may be selected based on, for example, geographic location and load (e.g., the number of sessions being handled by the UPF). For example, the SMF 408 may select an available UPF that is closest geographically to the UE device 402 of a particular session and that also has capacity to handle an additional session thereon and the associated data traffic. As discussed above, in some embodiments, an Internet service chain for a session for a UE device 402 can include a UPF 410, 412, 414, 416 and an Internet interface 440 corresponding to the UPF 410, 412, 414, 416. As mentioned above, each Internet interface 440 can correspond to a different service entity of the UPF. For example, a first Internet service chain can include the first UPF 410 and an Internet interface 440 corresponding to the first UPF 410. A second, different Internet service chain can include the second UPF 412 and an Internet interface 440 corresponding to the second UPF 412. A third, different Internet service chain can include the third UPF 414 and an Internet interface 440 corresponding to the third UPF 414.

In the embodiment illustrated in FIG. 4, the SMF 408 also includes an internet service disruption routing module 430 which is configured to redirect data traffic for each session handled by an Internet service chain if there is a failure of one or more components of the Internet service chain. For example, in some embodiments, if SMF 408 detects a failure of a UPF in a first Internet service chain (e.g., including first UPF 410, and the Internet interface 440 corresponding to the first UPF 410), the internet service disruption routing module 330 can select the second UPF 412 and corresponding Internet interface 440 (i.e., a second Internet service chain) and assign it to the sessions being handled by the first Internet service chain. In some embodiments, the internet service disruption module 430 may select a different UPF based on the geographical location of the UPF and load. Information regarding the UPF selected by the internet service disruption routing module 430 may be communicated to the AMF 406 and the RAN 404. The RAN 404 may then redirect data traffic over an interface 450 corresponding to the selected UPF.

FIG. 5 illustrates a method for routing data traffic for an Internet service in a communication network in accordance with an embodiment. The process illustrated in FIG. 5 is described as being carried out by the systems illustrated in FIGS. 3 and 4. Although the blocks of the process are illustrated in a particular order, in some embodiments, one or more blocks may be executed in a different order than illustrated in FIG. 5, or may be bypassed.

At block 502, a failure of a component in a first Internet service chain is detected, for example, by a UPF 310 or an SMF 408 in a wireless communication network. The first Internet service chain can have at least one assigned session associated with a UE device 302, 402. In some embodiments, the component failure may be a failure of an Internet interface 340, 342, 344, 346 (e.g., an N6 interface), for example, a loss of a firewall along the path, breakage of IP connectivity, malfunction in the DDOS gear, or any other disruption of the Internet interface. In some embodiments, the component failure may be a failure of a UPF (e.g., UPFs 410, 412, 414, 416) in the communication network, for example, a loss of a corresponding interface (e.g., an N4 interface) 480, 482, 484, 486.

At block 504, at least one component of a second internet service chain may be selected. As discussed above with respect to FIGS. 3 and 4, in some embodiments, an Internet service chain for a session for a UE device can include a UPF and an Internet interface corresponding to the UPF (e.g., to a particular service entity of the UPF). If the component failure is a failure of an Internet interface 340, 342, 344, 346, the UPF 310 may be configured to select a different Internet interface of the UPF 310 and the service entity 320, 322, 324, 326 corresponding to the selected Internet interface. For example, as discussed above with respect to FIG. 3, the UPF 310 can include an internet service disruption routing module 330 which can be configured to select a different service entity Internet interface (e.g., the second Internet interface) and the corresponding service entity (i.e., a second Internet service chain) and assign it to one or more of the sessions being handled by the first Internet service chain which has experienced the failure. If the component failure is a failure of a UPF 410, 412, 414, 416 (e.g., and the associated interface 480, 482, 484, 486 to the SMF 408) in the communication network, the SMF 408 may be configured to select a different UPF. For example, as discussed above with respect to FIG. 4, the SMF 408 can include an internet service disruption routing module 430 which can be configured select a different UPF (e.g., the second UPF) and corresponding Internet interface (i.e., a second Internet service chain) and assign it to the sessions being handled by the first Internet service chain which has experienced the failure.

At block 506, a signal may be transmitted to a radio access network (RAN) 304, 404 indicating the selected at least one component of the second internet service chain (e.g., a selected Internet interface/service entity or a UPF). For example, in some embodiments if the component failure is a failure of an Internet interface 340, 342, 344, 346, the internet service disruption routing module 330 on the UPF 310 may be configure to transmit control signaling to the SMF 308 which then communicates the signal to the AMF 306, which then communicates the signal with the RAN 304. In another example, in some embodiments if the component failure is a failure of a UPF, the internet service disruption routing module 430 on the SMF 408 may be configured to transmit control signaling to the AMF 406, which then communicates the signal with the RAN 304.

At block 508, the data traffic for the at least one assigned session of the first internet service chain may be redirected (or rerouted) to the at least one component of the second Internet service chain. In some embodiments, if the selected component of the second Internet service chain is an Internet interface 340, 342, 344, 346 (corresponding to a service entity 320, 322, 324, 326) of a UPF 310, the RAN 304 may redirect (or reroute) data traffic over the interface (e.g., an N3 interface) 350, 352, 354, 356 corresponding to the selected service entity and Internet interface of the UPF 310. In some embodiments, if the selected component of the second Internet service chain is a UPF 410, 412, 414, 416 (each having a corresponding Internet interface), the RAN 404 may redirect (or reroute) data traffic over an interface (e.g., an N3 interface) 450 corresponding to the selected UPF.

As mentioned above, various components of the communication network 100 and the disclosed systems in FIGS. 1-4 may be implemented on a computer system (e.g., a server). FIG. 6 is a block diagram of an example computer system in accordance with an embodiment. The computer system 600 (e.g., a server) may include one or more processor devices 602, a display 604, one or more inputs 606, one or more communications systems 608, and memory 610. In some embodiments, processor device(s) 602 can be any suitable hardware processor or combination of processors, such as a CPU, a GPU, an ASIC, an EPGA, etc. The processor device(s) 602 may include one or more processors, processor cores, processing elements, processor clusters, or other electronic processing units. Accordingly, a processing function described as being performed by the processor device(s) 602 may include multiple processors, processor cores processing elements, processing clusters, etc. (of processor device(s) 602) performing aspects or portions (subfunctions) of the processing function to complete the processing function. The one or more electronic processing units of the processor device(s) may include one or more microprocessors, application-specific integrated circuits (ASICs), or other suitable electronic device for processing data. At least in some examples, the one or more electronics processing units of the processor device(s) 602 can be co-located physically (e.g., in the same facility, building, room, rack, or computer housing) as part of the computer system 600.

In some embodiments, display 504 can include any suitable display devices, such as a computer monitor, a touchscreen, a television, etc. In some embodiments, display 604 can be omitted. In some embodiments, inputs 606 can include any suitable input devices and/or sensors that can be used to receive user input, such as a keyboard, a mouse, a touchscreen, a microphone, etc. In some embodiments, inputs 606 can be omitted.

In some embodiments, communications system(s) 608 can include any suitable hardware, firmware, and/or software for communicating information over any suitable communication network (e.g., communication network 108 shown in FIG. 1). For example, communication system(s) 608 can include one or more transceivers, one or more communication chips and/or chip sets, etc. In a more particular example, communications system(s) 608 can include hardware, firmware and/or software that can be used to establish a WiFi connection, a Bluetooth connection, a cellular connection, an Ethernet connection, etc.

In some embodiments, memory 610 can include any suitable storage device or devices (e.g., one or more non-transitory computer readable media) that can be used to store instructions, values, etc., that can be used, for example, by processor 602 to present content using display 604, to communicate with a UE 102 (shown in FIG. 1), to communicate with external data network (e.g., the Internet), to communicate with other computer systems (e.g., servers), etc. Memory 610 can include any suitable volatile memory, non-volatile memory, storage, or any suitable combination thereof. For example, memory 610 can include RAM, ROM, EEPROM, one or more flash drives, one or more hard disks, one or more solid state drives, one or more optical drives, etc. The memory 610 may store data and/or instructions for use and execution by the computer system 600 (e.g., by the processor device(s) 602) to implement the functionality of, for example, the RAN 106 and the 5G core 110, both shown in FIG. 1, and the internet service disruption routing module 330, 430 (shown in FIGS. 3 and 4. In some embodiments, the functionality described herein as being performed by the computer system 600 may be distributed among multiple computer system, servers, or devices (e.g., as part of a cloud service or cloud-computing environment).

In some examples, aspects of the technology, including computerized implementations of methods according to the technology, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, examples of the technology can be implemented as a set of instructions, tangibly embodied on a non-transitory computer-readable media, such that a processor device can implement the instructions based upon reading the instructions from the computer-readable media. Some examples of the technology can include (or utilize) a control device such as an automation device, a special purpose or general-purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.

Certain operations of methods according to the technology, or of systems executing those methods, can be represented schematically in the FIGs. or otherwise discussed herein. Unless otherwise specified or limited, representation in the FIGs. of particular operations in particular spatial order can not necessarily require those operations to be executed in a particular sequence corresponding to the particular spatial order. Correspondingly, certain operations represented in the FIGs., or otherwise disclosed herein, can be executed in different orders than are expressly illustrated or described, as appropriate for particular examples of the technology. Further, in some examples, certain operations can be executed in parallel, including by dedicated parallel processing devices, or separate computing devices configured to interoperate as part of a large system.

The present technology has been described in terms of one or more preferred embodiments, and it should be appreciated that many equivalents, alternatives, variations, and modifications, aside from those expressly stated, are possible and within the scope of the invention.

1. A method for routing data traffic for an Internet service in a communication network, the method comprising:
detecting, using an Internet service disruption routing module, a failure of a component in a first Internet service chain in the communication network, the first Internet service chain comprising a first user plane function (UPF), and a first Internet interface and the first Internet service chain having at least one assigned session;
selecting, using the Internet service disruption routing module, at least one component of a second Internet service chain;
transmitting, using the Internet service disruption routing module, a signal to a radio access network (RAN) in the communication network indicating the selected at least one component of the second Internet service chain; and
redirecting, using the RAN, data traffic for the at least one assigned session of the first Internet service chain to the at least one component of the second Internet service chain.

2. The method according to claim 1, wherein the first UPF comprises a plurality of service entities and each of the plurality of service entities has a corresponding Internet interface and a corresponding interface to the RAN.

3. The method according to claim 2, wherein the failure of a component in the first Internet service chain is a failure of the first Internet interface and the selected at least one component of a second Internet service chain is a second Internet interface corresponding to a service entity of the first UPF and an interface to the RAN.

4. The method according to claim 3, wherein the Internet service disruption routing module is associated with the first UPF.

5. The method according to claim 3, wherein the at least one assigned session of the first Internet service chain comprises a plurality of assigned sessions, the method further comprising:
selecting, using the Internet service disruption module, at least one component of a different Internet service chain in the communication network for each session assigned to the first Internet service chain;
transmitting, using the Internet service disruption routing module, a signal to the RAN indicating the selected at least one component of a different Internet service chain for each assigned session of the first Internet service chain; and
redirecting, using the RAN. data traffic for each assigned session of the first Internet service chain to the selected at least one component of a different Internet service chain for each assigned session.

6. The method according to claim 1, wherein the communication network comprises a plurality of UPFs.

7. The method according to claim 6, wherein the failure of a component in the first Internet service chain is a failure of the first UPF and the selected at least one component of a second Internet service chain is a second UPF of the plurality of UPFs.

8. The method according to claim 6, wherein the Internet service disruption routing module is associated with a session management function (SMF) of the communication network that is in communication with the plurality of UPFs.

9. A system for routing data traffic for an Internet service in a communication network, the system comprising:
a memory that stores one or more computer readable media that include instructions; and
one or more processor devices that execute the instructions of the computer readable media to perform a process comprising:
detecting a failure of a component in a first Internet service chain in the communication network, the first Internet service chain comprising a first user plane function (UPF) and a first Internet interface and the first Internet service chain having at least one assigned session;
selecting at least one component of a second Internet service chain;
transmitting a signal to a radio access network (RAN) in the communication network indicating the selected at least one component of the second Internet service chain; and
redirecting data traffic for the at least one assigned session of the first Internet service chain to the at least one component of the second Internet service chain.

10. The system according to claim 9, wherein the first UPF comprises a plurality of service entities and each of the plurality of service entities has a corresponding Internet interface and a corresponding interface to the RAN.

11. The system according to claim 10, wherein the failure of a component in the first Internet service chain is a failure of the first Internet interface and the selected at least one component of a second Internet service chain is a second Internet interface corresponding to a service entity of the first UPF and an interface to the RAN.

12. The system according to claim 11, wherein the at least one assigned session of the first Internet service chain comprises a plurality of assigned sessions, the process performed by the one or more processors further comprising:
selecting at least one component of a different Internet service chain in the communication network for each session assigned to the first Internet service chain;
transmitting a signal to the RAN indicating the selected at least one component of the different Internet service chain for each assigned session of the first Internet service chain; and
redirecting data traffic for each assigned session of the first Internet service chain to the selected at least one component of the different Internet service chain for each assigned session.

13. The system according to claim 9, wherein the communication network comprises a plurality of UPFs.

14. The system according to claim 13, wherein the failure of a component in the first Internet service chain is a failure of the first UPF and the selected at least one component of a second Internet service chain is a second UPF of the plurality of UPFs.

15. A non-transitory, computer-readable medium storing instructions that, when executed by an electronic processor, perform a set of functions, the set of functions comprising:
detecting, using an Internet service disruption routing module, a failure of a component in a first Internet service chain in the communication network, the first Internet service chain comprising a first user plane function (UPF) and a first Internet interface and the first Internet service chain having at least one assigned session;
selecting, using the Internet service disruption routing module, at least one component of a second Internet service chain;
transmitting, using the Internet service disruption routing module, a signal to a radio access network (RAN) in the communication network indicating the selected at least one component of the second Internet service chain; and
redirecting, using the RAN, data traffic for the at least one assigned session of the first Internet service chain to the at least one component of the second Internet service chain.

16. The computer-readable medium according to claim 15, wherein the first UPF comprises a plurality of service entities and each of the plurality of service entities has a corresponding Internet interface and a corresponding interface to the RAN.

17. The computer-readable medium according to claim 16, wherein the failure of a component in the first Internet service chain is a failure of the first Internet interface and the selected at least one component of a second Internet service chain is a second Internet interface corresponding to a service entity of the first UPF and an interface to the RAN.

18. The computer-readable medium according to claim 17, wherein the at least one assigned session of the first Internet service chain comprises a plurality of assigned sessions, and wherein the set of functions further comprises:
selecting, using the Internet service disruption module, at least one component of a different Internet service chain in the communication network for each session assigned to the first Internet service chain;
transmitting, using the Internet service disruption routing module, a signal to the RAN indicating the selected at least one component of a different Internet service chain for each assigned session of the first Internet service chain; and
redirecting, using the RAN. data traffic for each assigned session of the first Internet service chain to the selected at least one component of a different Internet service chain for each assigned session.

19. The computer-readable medium according to claim 15, wherein the communication network comprises a plurality of UPFs.

20. The computer-readable medium according to claim 19, wherein the failure of a component in the first Internet service chain is a failure of the first UPF and the selected at least one component of a second Internet service chain is a second UPF of the plurality of UPFs.
